(19) United States
(12) Patent Application Publication
(10) Pub. No.: US 2003/0128236 A1
(43) Pub. Date: Jul. 10, 2003

(54) Method and system for a self-adaptive personal view agent

(76) Inventor: Meng Chang Chen, Taipei (TW)

Correspondence Address: FISH & RICHARDSON PC, 225 FRANKLIN ST, BOSTON, MA, 02110, US

(21) Appl. No.: 10/043,648

(22) Filed: Jan. 10, 2002

(51) Int. Cl. G09G 5/00

(52) U.S. Cl. 345/745; 345/738; 345/744

(57) ABSTRACT

A self-adaptive personal view agent system is described. The system includes a proxy, a personal view constructor, and a personal view maintainer. The proxy keeps track of a user's Internet access activities, and extracts a topic page from web pages that have been accessed by the user. The personal view constructor builds a personal view, in a form of a hierarchy of categories, for the user based on the topic page extracted by the proxy. The personal view maintainer adjusts the personal view based on an energy value of each of the categories to reflect changes in the user's interest.

### TECHNICAL FIELD

This invention relates to a self-adaptive and personalized information agent that manages a personal view for its user.

### BACKGROUND

The World Wide Web (WWW) has significantly facilitated information distribution to people around the world. However, the rapid growth of Internet sites has made information retrieval from the WWW a time consuming task. Among the available WWW information retrieval tools, web search engines and web directory systems are the two most popular types. Web search engines, e.g., Google®, allow users to retrieve Web documents by entering keywords. Web directory systems, e.g., Yahoo!®, organize web documents in a hierarchical categorization structure that allows users to find relevant information via top-down navigations.

Although a search engine is a convenient tool for information searching on the Web, its ability to locate relevant documents with precision is usually low. A search engine may generate a large number of returned web pages in response to a single keyword. In contrast, a Web directory system usually has a better precision than a search engine. However, a Web directory system typically does not have an extensive coverage of all the available web pages on the Web, because the tasks of collecting the web pages and categorizing the pages are usually performed manually by system managers and sometimes by information providers. The search results generated by a web directory system are limited to the collected information, and therefore it is difficult for a web directory system to compete with a search engine in terms of web page coverage.

Personalization of the WWW access is another approach for Web information retrieval. In general, a personalization system constructs a user profile by learning from previously accessed data that contains information about the topics that are of interest to the user. The personalization system then utilizes the user profile to assist the user in retrieving interesting information from the Web. However, the existing personalization systems often require the user to provide input or feedback before a meaningful result can be generated.

### SUMMARY

In one aspect of the invention, the invention relates to a Personal View Agent (PVA) system that manages a personal view for a user. The system includes a proxy, a personal view constructor, and a personal view maintainer. The proxy tracks web pages that have been accessed by the user and extracts a topic page from the web pages; the personal view constructor builds the personal view as a hierarchy of categories based on the topic page extracted by the proxy; and the personal view maintainer adjusts the hierarchy according to an energy value of each of the categories.

Embodiments of this aspect of the invention may include one or more of the following features.

The personal view constructor maps the topic page into a selected category in a superset of categories and updates a corresponding category in the hierarchy. The selected category has a category vector most similar to a keyword vector of the topic page. If the selected category is not in the hierarchy, the corresponding category is an ancestor of the selected category in the superset of categories.

If the energy value of a parent category is above a pre-determined threshold, the personal view maintainer splits off a child category from the parent category in the hierarchy. The personal view maintainer chooses the child category that maximizes a gain value.

The personal view maintainer periodically reduces the energy value of each of the categories. If the energy value of a child category is below a pre-determined threshold, the personal view maintainer removes the child category from the hierarchy. The personal view maintainer merges information of the child category with information of the child category's parent in the hierarchy.

In certain embodiments of this aspect of the invention, the system further includes a personal view display to display the hierarchy of categories.

In another aspect of the invention, the invention relates to a method for managing a personal view for a user. The method includes tracking web pages that have been accessed by the user; extracting a topic page from the web pages; building the personal view as a hierarchy of categories based on the topic page; and adjusting the hierarchy according to an energy value of each of the categories.

Embodiments of this aspect of the invention may include one or more of the following features.

The method may include mapping the topic page into a selected category in a superset of categories and updating a corresponding category in the hierarchy. The selected category has a category vector most similar to a keyword vector of the topic page. The method may also include choosing the corresponding category that is an ancestor of the selected category in the superset of categories.

The method may further include splitting off a child category from a parent category in the hierarchy if the energy value of the parent category is above a pre-determined threshold. The child category is chosen to maximize a gain value.

The energy value of each of the categories is reduced periodically. If the energy value of a child category is below a pre-determined threshold, the child category is removed from the hierarchy. The information of the child category is merged with information of the child category's parent in the hierarchy.

In certain embodiments of this aspect of the invention, the method may further include alerting the user that new information has been added to the categories.

In yet another aspect of the invention, the invention relates to a computer program product residing on a computer readable medium comprising instructions for causing the computer to track web pages that have been accessed by the user; extract a topic page from the web pages; build a personal view for a user as a hierarchy of categories based on the topic page; and adjust the hierarchy according to an energy value of each of the categories.

Embodiments of this aspect of the invention may include one or more of the following features. The computer program product may further include instructions for causing the computer to map the topic page into a selected category in a superset of categories and update a corresponding category in the hierarchy. The computer program product may further include instructions for causing the computer to split off a child category from a parent category in the hierarchy if the energy value of the parent category is above a pre-determined threshold. The computer program product may further include instructions for causing the computer to merge information of the child category with information of the child category's parent in the hierarchy.

Embodiments may have one or more of the following advantages. Users usually have interests in multiple domains. The PVA models each of the domains as a separate vector in a vector space model, and organizes the vectors into a hierarchical structure called a personal view. Each node in the personal view represents a topic that describes the user's interest. The PVA builds the personal view based on the previously-accessed data obtained from the user's Internet access activities. The user is not required to provide input or feedback to the PVA. The PVA also updates the personal view to adapt to the changes in the user's interest over time.

The hierarchical representation of a personal view is efficient for information search. The hierarchical representation provides a general-to-specific information structure that allows the search to proceed in a top-down fashion that is both intuitive and user-friendly.

Other features, objects, and advantages of the invention will be apparent from the description and drawings, and from the claims.

### DESCRIPTION OF DRAWINGS

FIG. 1 is a system diagram of a personal view agent (PVA);

FIG. 2 is an example of the PVA that computes a keyword vector from a web page;

FIG. 3 is a personal view generated by the PVA;

FIG. 4 shows two examples of inserting a page into a category of the personal view;

FIG. 5 is an example of updating a category vector after new pages are inserted into the category;

FIG. 6A is an algorithm for splitting a category to generate a child category; and

FIG. 6B is an algorithm for merging categories in the personal view.

Like reference symbols in the various drawings indicate like elements.

### DETAILED DESCRIPTION

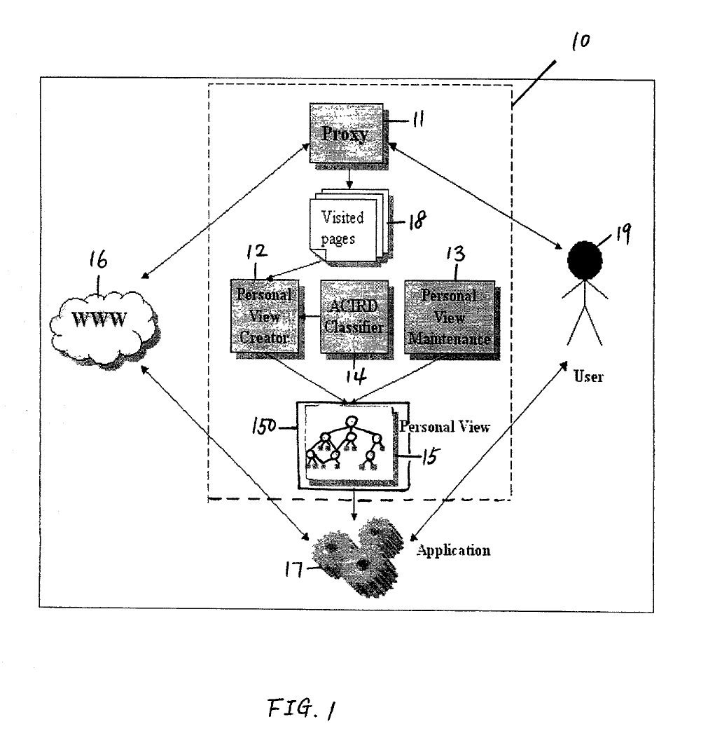

Referring to FIG. 1, a personal view agent (PVA) system 10 provides an interface between a user 19 and the World-Wide Web (WWW) 16. Every time user 19 accesses a web page on WWW 16, PVA system 10 updates a personal view 15 in a database 150. Database 150 may locally reside in PVA system 10 or remotely accessible by the system. Personal view 15 is a user profile and provides a hierarchy of categories that contains information about the web pages that have been visited by the user. The information can be used by a software application 17 (e.g., a news filtering application) to increase efficiency and precision for retrieving information from WWW 16. PVA system 10 may be located on a local computer or on a remote server accessible to user 19 via a network.

PVA system 10 includes a proxy 11 that tracks and analyzes a user's preference for web sites. When user 19 accesses WWW 16, the user's web access activities are tracked by proxy 11 and saved in a log file. Periodically (e.g., every day), proxy 11 analyzes the log file and produces analysis results in the form of visited pages 18. Proxy 11 employs analytical techniques that use web access parameters (e.g., page view frequency, link visit percentage, and page browsing time) to measure the degree of the user's interest in a page. For example, pages with browsing times longer than a pre-set threshold (e.g., two minutes) are sent to a personal view constructor (PVC) 12 included within PVA system 10.

PVA system 10 also includes a classifier 14 (e.g., an ACIRD classifier) used by PVC 12 to classify visited pages 18 into one of the pre-determined categories. PVC 12 constructs personal view 15 for user 19 based on the classification results from classifier 14. PVA system 10 further includes a personal view maintainer (PVM) 13 that manages the content and structure of the hierarchy of categories of personal view 15.

PVC 12 parses the web pages sent from proxy 11 to extract specific information called terms. A term, for example, can be any word or phrase. PVC 12 may use a stop-word list to exclude certain words that do not possess definite meanings, e.g., “the”, “a”, or “that”, from the extracted terms. In a language that is composed of complex composite words, e.g., Chinese, a dictionary may be used to identify the terms.

The frequency of occurrences of a term in a web page is represented by a weight. The weight is normalized by the maximum frequency of all of the terms in the web page. The terms and their corresponding weights form a keyword vector of that web page. For each term tᵢ in a page P, PVC 12 calculates its weight W_{i,p} according to the following formula:

$${W}_{i , p} = \frac{{freq}_{i , p}}{{MAX}_{j} \{ {freq}_{j , p} \}} , \qquad ( Eqn . 1 )$$

where freq_{i,p} is the frequency of term tᵢ in page P.

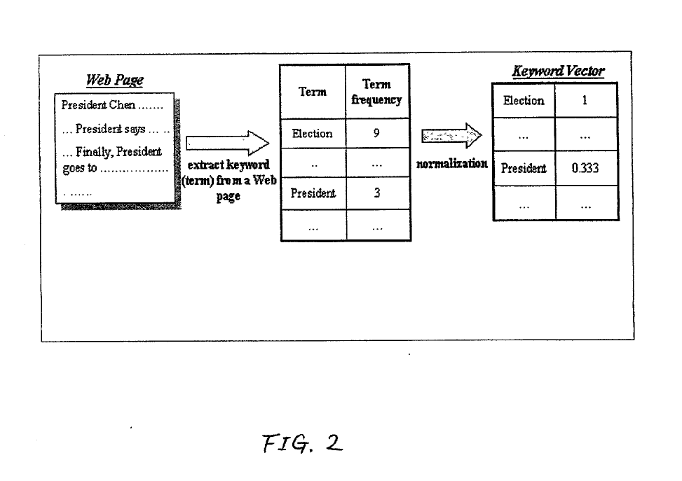

FIG. 2 shows an example in which PVC 12 computes a keyword vector for a web page P. For the purpose of simplifying the discussion, the keyword vector of P includes only two terms, which are “election” and “president”. The frequencies of the two terms are 9 and 3, respectively. The normalized weights for the two terms are, 1 and 0.333, which are computed from dividing frequencies by the maximum frequency of 9. The resulting keyword vector for web page P is {(election, 1), (president, 0.333)}.

PVC 12 builds personal view 15 as a hierarchy of categories from the keyword vectors. Each category includes information about a domain of user interest and the history of the user's activities in that domain. Each category has a predetermined category vector defining a topic of interest, and an energy value that indicates the degree of interest in that category. The energy of a category increases when the user accesses web pages belonging to that category, and decreases by a constant value at a pre-defined time intervals. Categories with high energy value will split into sub-categories to record the user interests in a higher level of detail. Categories that receive little attention from the user will gradually be outdated and removed.

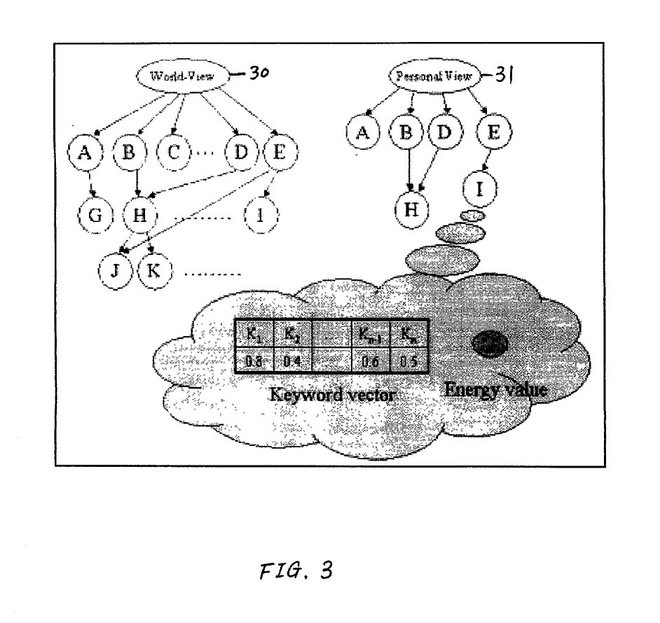

Referring to FIG. 3, PVC 12 uses classifier 14 to categorize a web page into one of the categories defined in a world view 30. World view 30 is a hierarchy of categories that includes all of the categories recognized by PVA system 10. In other words, world view 30 is a superset of all of the categories. World view 30 also defines the dependencies among these categories. A user's personal view 15 is a subset of world view 30.

Classifier 14 classifies a web page based on its keyword vector. Classifier 14 determines whether a keyword vector of a web page P belongs to a category C by calculating the following cosine similarity sim (P,C) relationship:

$$sim ( P , C ) = \frac{{\sum }_{k} ( {w}_{P , k}^{′} \times {w}_{C , k} )}{\sqrt{{\sum }_{k} {( {w}_{P , k} )}^{2}} \times \sqrt{{\sum }_{k} {( {w}_{C , k} )}^{2}}} \qquad ( Eqn . 2 )$$

where W_{P,k} and W_{C,k} are the weights of term k of page P and category C, respectively, and W′_{P,k} is the weight of term k after a rearrangement operation is performed, which is described below.

Referring again to the example of FIG. 2, the keyword vector of web page P is {(election, 1), (president, 0.333)}. Assume that world view 30 includes two categories C₁ and C₂, whose category vectors are {(government, 1), (president, 0.4)} and {(president, 1), (judicature, 0.7)}, respectively. Before computing sim(P,C₁) and sim(P,C₂), classifier 14 re-arranges the keyword vector so that it conforms to the category vectors of C₁ and C₂. In one scenario, classifier 14 sorts the terms of the keyword vector according to the ordering of the terms in a category vector, and then removes the terms that do not exist in the category vector. For example, sim(P,C₁) is computed from the re-arranged keyword vector {(null, 0), (president, 0.333)}. Applying (Eqn. 2) to the keyword vector and the category vector of C₁ by using w_{p,1}=1, w_{p,2}=0.333, w′_{p,1}=0, w′_{p,2}=0.333, w_{c1,1}=1, w_{c1,2}=0.4, sim(P,C₁) is equal to 0.11. Similarly, sim(P,C₂) is equal to 0.25. Therefore, page P is classified under category C₂.

After a web page is classified into a category, PVC 12 determines whether this category exists in personal view 15. If the classified category exists in personal view 15, PVC 12 will insert the page into that category directly. If the classified category does not exist in personal view 15 but only exists in world view 30, PVC 12 will insert the page into a category which is a closest non-root ancestor to the classified category. If no such ancestor exists in personal view 15, PVC 12 will add a new category, directly below the root, that is an ancestor of the classified category. PVC 12 then inserts the page into the new category.

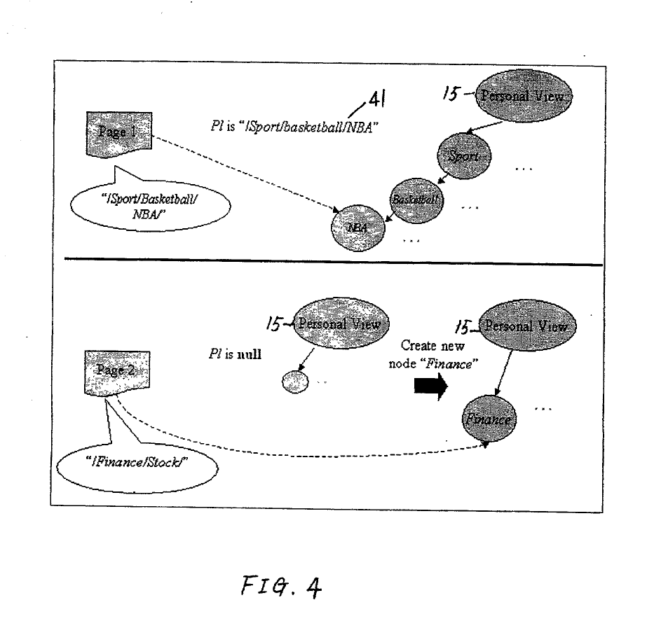

Referring to FIG. 4, a web page, Page 1, of a professional basketball team is classified into the category “NBA.” The classification path of “NBA”, which is a path from the root to the category, is “/Sport/Basketball/NBA/” 41. Because the category “NBA” exists in personal view 15, Page 1 is inserted to “NBA” directly. Page 2 is classified into the category “stock,” which has the classification path “/Finance/Stock”. Neither the category “Stock” nor its parent “Finance” exists in personal view 15. Therefore, PVC 12 adds the category “Finance” into personal view 15 and then inserts Page 2 into “Finance.”

After these pages are inserted into personal view 15, PVC 12 updates the category vectors in the personal view and the energy values of each category affected by the page insertion. The weights of a category vector for a category Cᵢ is updated as follows:

$${V}_{i} = \frac{{\sum }_{p ∈ {P}_{i}^{new}} {V}_{p}}{\vert {P}_{i}^{new} \vert} + α * {V}_{i} , \qquad ( Eqn . 3 )$$

where Vᵢ is the keyword vector of category Cᵢ, Pᵢ^{new} is the set of pages that are most recently inserted into category Cᵢ, |Pᵢ^{new}| is the number of pages in Pᵢ^{new}, and Vₚ is the keyword vector of a page in Pᵢ^{new}. The parameter α, called the aging factor, is set to a value between 0 to 1 to reduce the contribution of the web pages that existed in the categories before the page insertion. A smaller value of α indicates smaller contribution of these existing web pages.

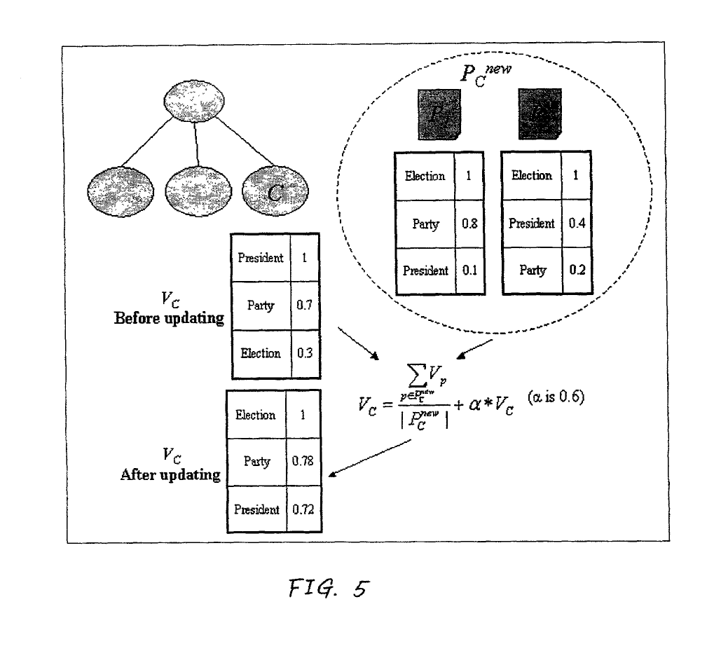

FIG. 5 illustrates an example of updating a category vector V_{c} after two new pages P₁ and P₂ are inserted into category C. The aging factor in the example is 0.6.

After the keyword vectors are updated, PVC 12 updates the energy value for each category that receives new pages. The energy value of a category is the sum of the cosine similarities between the category vector and the inserted pages. The energy value increases when web pages are inserted into the category. The energy value are updated according to the following formula:

$${E}_{i} = {E}_{i} + {\sum }_{p ∈ {P}_{i}^{new}} cos ( {V}_{i} , {V}_{p} ) , \qquad ( Eqn . 4 )$$

where Eᵢ is the energy value of category Cᵢ, and cos(Vᵢ,Vₚ) is the cosine similarity between the category vector of Cᵢ and the keyword vector of page P.

In addition to tracking and recording user interests, PVA system 10 is adaptive to the changes of user interests. For example, a sports fan may shift his or her attention to the NBA after the MLB finals. To adapt to such changes, PVM 13 periodically adjusts the structure of personal view 15 by using two maintenance operators, split and merge.

As described above with reference to FIG. 4, a web page is inserted to an ancestor of a category if the category does not exist in personal view 15. As a result, an ancestor category usually contains a large number of the terms in its sub-categories (i.e., children). For example, the category vector of the category “Sport” in the personal view of a sports fan might include the terms in the sub-categories “Basketball,” “Baseball,” and “Tennis.” If the user has a strong interest in one sub-category, that sub-category will dominate the content of the parent category. Detailed information of other sub-categories will be reduced or even lost. PVM 13 corrects this situation by using the split operator to split off the dominant child from its parent.

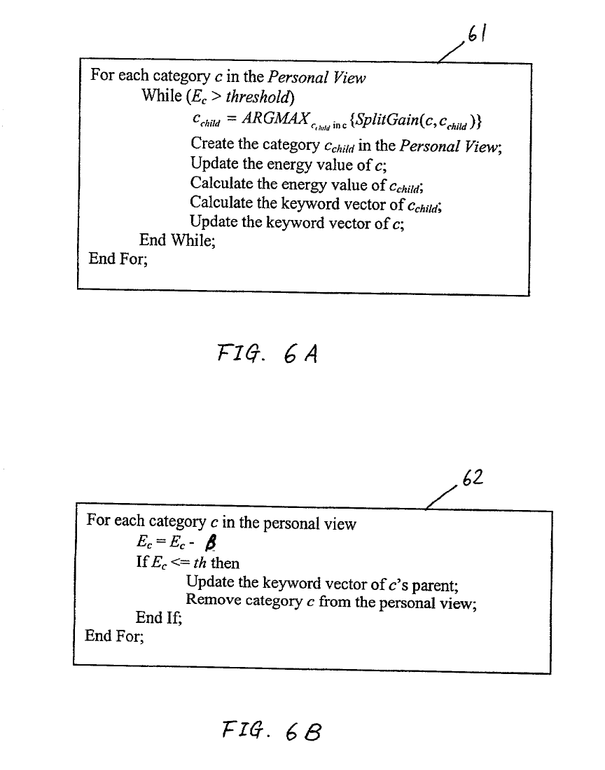

Referring to FIG. 6A, an algorithm 61 for the split operation is described. First, each category's energy value is compared against a pre-defined threshold. If the category's energy value is greater than the threshold, one of its children will be split off from the category. The split-off child is the child that generates a maximal SplitGain after it is split from the parent.

The function SplitGain defined below computes the gain generated from splitting off a child from its parent:

$$SplitGain ( {C}_{parent} , {C}_{child} ) = Ent ( {C}_{parent} ) - \frac{\vert {C}_{parent - child} \vert}{\vert {C}_{parent} \vert} Ent ( {C}_{parent - child} ) , \qquad ( Eqn . 5 )$$

where C_{parent-child} is the category Cₚₐᵣₑₙₜ excluding all the pages belonging to C_{child}. The notation |C| for a category C represents the number of pages in category C. The function Ent(C) is the entropy value of the category C, which is defined as

$$Ent ( C ) = - {\sum }_{c ∈ {C}_{sub}} P ( c ) ln P ( c ) , \qquad ( Eqn . 6 )$$

where C_{sub} is the set of all of C's children, and P(c) is the ratio of the documents (i.e., pages) in category c (a child) to all the documents in C (the parent). The entropy is maximal if each child in C has an equal number of documents, and it is minimal if all the documents in C belong to the same child. The SplitGain function returns the entropy reduction after a child is split from its parent.

When PVC 12 inserts new pages into personal view 15, the classification information is stored into two tables. One table keeps the number of documents per category, and the other records the document frequency of each term. Hence, the value P(c) can be easily obtained by looking up the tables.

After a new child category is split from its parent, PVM 13 adjusts the keyword vectors and energy values of both categories. The energy values are updated as follows:

$$\begin{matrix}{E}_{parent - child} = {E}_{parent} * \frac{\vert {C}_{parent} . \vert}{\vert {C}_{parent} . \vert + \vert {C}_{child} \vert} , \\ {E}_{child} = {E}_{parent} * \frac{\vert {C}_{child} . \vert}{\vert {C}_{parent} \vert + \vert {C}_{child} \vert} ,\end{matrix} \qquad ( Eqn . 7 )$$

where Eₚₐᵣₑₙₜ is the energy value of the parent category before the splitting, E_{child} is the energy value of the newly generated child category, and E_{parent-child} is the energy value of the parent category after the splitting. The updated energy values reflect the change in the number of documents in each of the categories.

Similarly, PVM 13 adjusts the weights of keyword vectors of the parent and child categories according to the number of documents in each of the two categories. The category vector of the child category is updated as follows:

$$\begin{matrix}{W}_{i , child}^{\sim} = {W}_{i , parent} * \frac{{df}_{i , child}}{{df}_{i , parent} + {df}_{i , child}} , \\ {W}_{i , child} = \frac{{W}_{i , child}^{\sim}}{{MAX}_{j} \{ {W}_{j , child}^{\sim} \}} ( normalization ) ,\end{matrix} \qquad ( Eqn . 8 )$$

where W_{i,child} and W_{i,parent} are the weights of term i in the child and parent categories, respectively, and df_{i,child} and df_{i,parent} are the document frequencies (i.e., the number of documents) of term i in the child and parent categories, respectively.

PVM 13 also adjusts the weights of the category vector of the parent category

$$\begin{matrix}{W}_{i , parent}^{\sim} = {W}_{i , parent} * \frac{{df}_{i , parent}}{{df}_{i , parent} + {df}_{i , child}} , \\ {W}_{i , parent} = \frac{{W}_{i , parent}^{\sim}}{{MAX}_{j} \{ {W}_{j , parent}^{\sim} \}} ( normalization ) ,\end{matrix}$$

according to the following formula:

(Eqn. 9)

where df_{i,parent}/(df_{i,parent}+df_{i,child}) is the number of documents containing term i in the parent category after the split operation is performed.

PVM 13 uses the merge operator to remove categories that are no longer of interest to the user. When no or few documents are added to a category, the energy value of the category will gradually decline due to the periodical energy reduction described above. PVM 13 removes categories with low energy values to reflect the user's current interest. Before a low energy category is deleted, the content of the category is merged with the content of its parent.

Referring to FIG. 6B, an algorithm 62 for the merge operation is described. The algorithm first reduces the energy value of every category periodically at a rate called a recession rate. Parameter β, called the decayfactor, is used to control the recession rate. If a category's energy value is less than or equal to a pre-defined threshold (i.e., th in algorithm 62), PVM 13 removes the category from personal view 15 and merges its category vector with that of its parent. PVM 13 further updates the energy value of the parent by adding the child's energy value to the parent's energy value. PVM 13 then updates the weights of the parent's category vector by using the following formula:

$$\begin{matrix}{W}_{i , parent}^{\sim} = {W}_{i , parent} * ( 1 + \frac{{df}_{i , child}}{{df}_{i , parent}} ) , \\ {W}_{i , parent} = \frac{{W}_{i , parent}^{\sim}}{{MAX}_{j} \{ {W}_{j , parent} \}} ( normalization ) .\end{matrix} \qquad ( Eqn . 10 )$$

The split and merge operators are inverse to each other, i.e., W_{i,parent}=merge(split(W_{i,parent}), as shown in the following calculation:

$$\begin{matrix}merge ( split ( {W}_{i , parent} ) ) = {W}_{i , parent} * \frac{{df}_{i , parent}}{{df}_{i , parent} + {df}_{i , child}} * ( 1 + \frac{{df}_{i , child}}{{df}_{i , parent}} ) \\ = {W}_{i , parent} * \frac{{df}_{i , parent}}{{df}_{i , parent} + {df}_{i , child}} * \frac{{df}_{i , parent} + {df}_{i , child}}{{df}_{i , parent}} \\ = {W}_{i , parent} .\end{matrix} \qquad ( Eqn . 11 )$$

Other embodiments are within the scope of the following claims.

What is claimed is:

1. A system for managing a personal view for a user comprising:
a proxy, which tracks web pages that have been accessed by the user and extracts a topic page from the web pages;
a personal view constructor, which builds the personal view as a hierarchy of categories based on the topic page extracted by the proxy; and
a personal view maintainer, which adjusts the hierarchy according to an energy value of each of the categories.

2. The system of claim 1 wherein the personal view constructor builds the personal view by mapping the topic page into a selected category in a superset of categories and updating a corresponding category in the hierarchy.

3. The system of claim 2 wherein the selected category has a category vector that is most similar to a keyword vector of the topic page.

4. The system of claim 2 wherein the corresponding category is an ancestor of the selected category in the superset of categories if the selected category is not in the hierarchy.

5. The system of claim 1 wherein the personal view maintainer splits off a child category from a parent category in the hierarchy if the energy value of the parent category is above a predetermined threshold.

6. The system of claim 5 wherein the personal view maintainer chooses the child category that maximizes a gain value.

7. The system of claim 1 wherein the personal view maintainer periodically reduces the energy value of each of the categories.

8. The system of claim 7 wherein the personal view maintainer removes a child category from the hierarchy if the energy value of the child category is below a pre-determined threshold.

9. The system of claim 7 wherein the personal view maintainer merges information of the child category with information of the child category's parent in the hierarchy.

10. The system of claim 1 further comprising a personal view display to display the hierarchy of categories.

11. A method for managing a personal view for a user comprising:
tracking web pages that have been accessed by the user;
extracting a topic page from the web pages;
building the personal view as a hierarchy of categories based on the topic page; and
adjusting the hierarchy according to an energy value of each of the categories.

12. The method of claim 11 wherein building the personal view further comprises:
mapping the topic page into a selected category in a superset of categories; and
updating a corresponding category in the hierarchy.

13. The method of claim 12 wherein the selected category has a category vector most similar to a keyword vector of the topic page.

14. The method of claim 12 further comprising choosing the corresponding category that is an ancestor of the selected category in the superset of categories.

15. The method of claim 11 further comprising splitting off a child category from a parent category in the hierarchy if the energy value of the parent category is above a pre-determined threshold.

16. The method of claim 15 further comprising choosing the child category that maximizes a gain value.

17. The method of claim 11 further comprising periodically reducing the energy value of each of the categories.

18. The method of claim 17 further comprising removing a child category from the hierarchy if the energy value of the child category is below a pre-determined threshold.

19. The method of claim 17 further comprising merging information of the child category with information of the child category's parent in the hierarchy.

20. The method of claim 11 further comprising alerting the user that new information has been added to the categories.

21. A computer program product residing on a computer readable medium comprising instructions for causing the computer to:
track web pages that have been accessed by the user;
extract a topic page from the web pages;
build a personal view for a user as a hierarchy of categories based on the topic page; and
adjust the hierarchy according to an energy value of each of the categories.

22. The computer program product of claim 21 wherein building a personal view further comprises instructions for causing the computer to:
map the topic page into a selected category in a superset of categories; and
update a corresponding category in the hierarchy.

23. The computer program product of claim 21 further comprising instructions for causing the computer to split off a child category from a parent category in the hierarchy if the energy value of the parent category is above a pre-determined threshold.

24. The computer program product of claim 21 further comprising instructions for causing the computer to merge information of the child category with information of the child category's parent in the hierarchy.
